(19) United States
(12) Patent Application Publication
(10) Pub. No.: US 2009/0284219 A1
(43) Pub. Date: Nov. 19, 2009

(54) Little Power House Emergency Power System

(76) Inventor: Ronald L. Meek, Anderson, IN (US)

Correspondence Address: RITCHISON LAW OFFICES, PC, 115 EAST NINTH STREET - SUITE A, ANDERSON, IN, 46016-1507, US

(21) Appl. No.: 12/465,044

(22) Filed: May 13, 2009

Related U.S. Application Data
(63) Continuation of application No. 61/053,116, filed on May 14, 2008.

(51) Int. Cl. H02J 7/00

(52) U.S. Cl. 320/107

(57) ABSTRACT

A back-up emergency power unit called the Little Power House Emergency Power System. The device provides unique features and combinations of features that are specifically used to charge a battery, retain power, then invert the stored power for use in the event of a power failure. The device 31 is comprised of a three way power switch 32 with a neutral \acute{Ø}; an outlet 90; an inverter 34; a battery 40; a three way charge switch 80; a float charge device 36; a transformer 55; and electrical means to interconnect all the components. The entire device is encased in a compact configuration.

### CROSS-REFERENCE TO RELATED APPLICATIONS

This application claims the benefit of Provisional Patent Application Ser. No. 61/053,116 filed May 14, 2008 by Ronald L. Meek and entitled Little Power House Emergency Power System (120 Volt).

### FIELD OF INVENTION

This invention relates to a back-up emergency power system (120 Volt). Particularly this new Little Power House Emergency Power System (120 Volt) is related to devices and methods to permit a person to have reserve and back-up power during a power outage. The preferred embodiment is described below.

### FEDERALLY SPONSORED RESEARCH

None

### SEQUENCE LISTING OR PROGRAM

None

### BACKGROUND

Field of Invention and Prior Art

A. Introduction of the Problems Addressed

Many individuals suffer when the lights go out. Power outages that leave workers, students, and homeowners in the dark can be frustrating. Without backup lighting such as candles or flashlights nearby, an individual can remain stagnant, waiting for the lights to come back on. The solution is a Little Power House that provides emergency lighting when needed. This system can be used during a power outage caused by inclement weather or manmade problem. The product is ideal for use by a homeowner, factory worker, or businessman and will prove useful in a home, factory, or office.

In this back-up power industry, there have been attempts made to address the problem, however none anticipate or demonstrate the solution and embodiment shown here. The features provided by the Little Power House Emergency Power System address the shortcomings of other back-up systems. e It is believed that this device is made with improved configurations and physical features to provide more functionality when compared to other currently utilized devices. The particular combinations of materials and features are unique and novel and are not anticipated by prior art. Likewise, use of a Little Power House Emergency Power System provides significant benefits compared to prior art devices.

B. Prior Art

Examples of prior devices include U.S. Pat. No. 5,138,185 issued to Weinstock (1992) and entitled “Electrical backup interface device having low power output”. This invention teaches a portable module that provides an interface between alternating current wall outlets and appliances for the purpose of maintaining an appliance in a quiescent state for a preselected period of time if the alternating current power at the wall outlet fails. The module includes a battery and a direct current to alternating current low power inverter that are effectively out of the circuit when AC power is being delivered to the appliance but which are brought into the circuit when the AC power to the appliance is interrupted. The inverter supplies enough power to keep digital clocks or other low power-requiring auxiliary units contained within the appliance from stopping so that they need not be reset if the outage is brief. The Little Power House Emergency Power System is not restricted to use by one device such as a clock or timer. Rather it provides a fully charged back-up with a standard outlet available to various devices needing electrical power.

A further and more recent example of a power back-up is shown by Johnson in U.S. Pat. No. 6,593,723 (2003) and entitled “Integrated wall apparatus for delivering uninterrupted electrical power”. This teaches an apparatus for providing uninterrupted electrical power includes a pair of guide tracks mounted to adjacent studs within a wall structure. A rechargeable battery may be mounted for slidable movement along the guide tracks such that additional batteries may be added successively or removed. The apparatus includes a logic circuit electrically connected to a power source and to the battery. A control panel provides access to the circuit and battery. A plurality of electrical outlets are positioned on the control panel. A master selector switch on the control panel is connected to the logic circuit and controls whether the outlets receive power from the conventional power source, from the battery when conventional power is unavailable, or not at all. Individual selector switches regulate whether particular receptacles may receive battery power. A plurality of dials are positioned on the control panel for user regulation of current voltage delivered to particular outlets. The Little Power House Emergency Power System is not integrated into the wall and is greatly simplified. It mounts exterior to the wall and is plugged into an extension or directly to the wall duplex outlet.

Another recent example of a power outage system is shown by Goff in U.S. Pat. No. 7,268,518 (2007) and entitled “Battery charger and emergency power supply assembly”. This teaches a battery charger and emergency power supply assembly that includes a housing. A switch is positioned in the housing and electrically coupled to a power supply. At least one electrical plug outlet is mounted in the housing and electrically coupled to the switch. A battery charger is mounted within the housing and is electrically coupled to the power supply. Each of a plurality of charging ports extends into the housing and is electrically coupled to the battery charger. Each of a plurality of rechargeable batteries includes plug members adapted for electrically coupled to the charging ports. An inverter is electrically coupled to each of the charging ports. The inverter is also electrically coupled to the switch. The switch may selectively open a circuit between the plug outlet and the power supply or the plug outlet and the inverter. This is very complex and relatively more expensive when compared to the Little Power House Emergency Power System

As far as known, there is no other back-up power devices at the present time which fully provides these improvements and functional characteristics as the present Little Power House Emergency Power System. It is believed that this device is made with physical features to provide more unique functionality when compared to other power back-up devices. The particular combinations of materials and features are unique and novel and are not anticipated by prior art.

### SUMMARY OF THE INVENTION

A Little Power House Emergency Power System has been developed and designed to provide a unique feature and combination that is specifically related to providing back-up emergency power. The device is made of high quality materials.

The preferred embodiment of the Little Power House Emergency Power System is comprised of:

(a) a three way power switch 32 with a neutral \acute{Ø};

(b) an outlet 90;

(c) an inverter 34;

(d) a battery 40;

(e) a three way charge switch 80;

(f) a float charge device 36;

(g) a transformer 55;

(h) and electrical means to interconnect all the components. The entire Little Power House Emergency Power System 31 of components and means are contained in an encasement 60 with a cover panel 33 in a compact configuration. An alternative embodiment has a means to connect 61 a power source 32 to the power switch 70 of the device 31, where the means is a power cord 25.

### Objects and Advantages

There are several objects and advantages of the Little Power House Emergency Power System. The following TABLE A summarizes various advantages and objects of the Little Power House Emergency Power System. This list is exemplary and not limiting to the many advantages offered by this new device.

TABLE A
Various Benefits, Advantages and Objects

| ITEM | BENEFIT |
|---|---|
| 1. | Lasting power |
| 2. | Trickle charge keeps the back-up at maximum capacity |
| 3. | Is safe and made of readily available components and |
| | materials. |
| 4. | Requires no new processes for manufacture. |
| 5. | Is adaptable to various sizes (Small, Medium, Large |
| | and extra Large) and low to high volume productions. |
| 6. | Is easy to package. |
| 7. | Can be sold and distributed retail, wholesale, or E- |
| | commerce internet sales from a website. |
| 8. | Is easy to transport. |

For one skilled in the art of emergency power back-up systems, it is readily understood that the features shown in the examples with this device are readily adapted for improvement to other types of devices for use with power back-up devices.

### DESCRIPTION OF THE DRAWINGS—FIGURES

The accompanying drawings, which are incorporated in and constitute a part of this specification, illustrate a preferred and alternative embodiments for the Little Power House Emergency Power System. The drawings together with the summary description given above and a detailed description given below serve to explain the principles of the Little Power House Emergency Power System. It is understood, however, that the device is not limited to only the precise arrangements and instrumentalities shown.

FIGS. 1A and 1B shows the internal components of the Little Power House from the side (left) and front (right).

FIGS. 2A and 2B are sketches that depict the unit plugged into an outlet.

FIGS. 3A and 3B are additional sketches that feature a close view of the product.

FIGS. 4A, 4B, and 4C illustrate the product (left) and in use (right) and schematic/flowchart of the system.

FIGS. 5A and 5B highlight various colors and designs of the Little Power House.

### DESCRIPTION OF THE DRAWINGS—REFERENCE NUMERALS

The following list refers to the drawings:

| Ref # | Description |
|---|---|
| 31 | General Little Power House Emergency Power |
| | System |
| 32 | Wall power - 110 volt duplex |
| 33 | Cover panel |
| 34 | Inverter |
| 35 | Cord to user device |
| 36 | Float Charger |
| 39 | Cover handle |
| 40 | Battery |
| 50 | Switch Cavity or shelf |
| 55 | transformer |
| 60 | Encasement |
| 61 | Means to electrically connect wall power to |
| | SW 1 |
| 62 | Means to electrically connect SW 1 outlet 90 |
| 63 | Means to electrically connect SW1 to neutral \acute{Ø} |
| 64 | Means to electrically connect inverter to SW 1 |
| 65 | Means to electrically connect inverter to |
| | battery |
| 66 | Means to electrically connect inverter to SW 2 |
| 67 | Means to electrically connect float to SW 2 |
| 68 | Means to electrically connect float to |
| | transformer |
| 69 | Means to electrically connect transformer to |
| | wall power Means to electrically connect |
| | outlet to SW 1 |
| 70 | Switch 1 (power from) |
| 80 | Switch 2 (Charge battery or use battery) |
| 90 | Output duplex |
| 20 | Wall for mounting |
| 25 | Optional cord from wall power 32 to device 31 |
| W | Wall |
| I | Inverter |
| F | Float |
| \acute{Ø} | Neutral position - no power out |

### Detailed Description of Preferred Embodiment

The present invention is a Little Power House Emergency Power System 31. Particularly the preferred embodiment of the Little Power House Emergency Power System 31 is related to devices and methods that provide back-up emergency power.

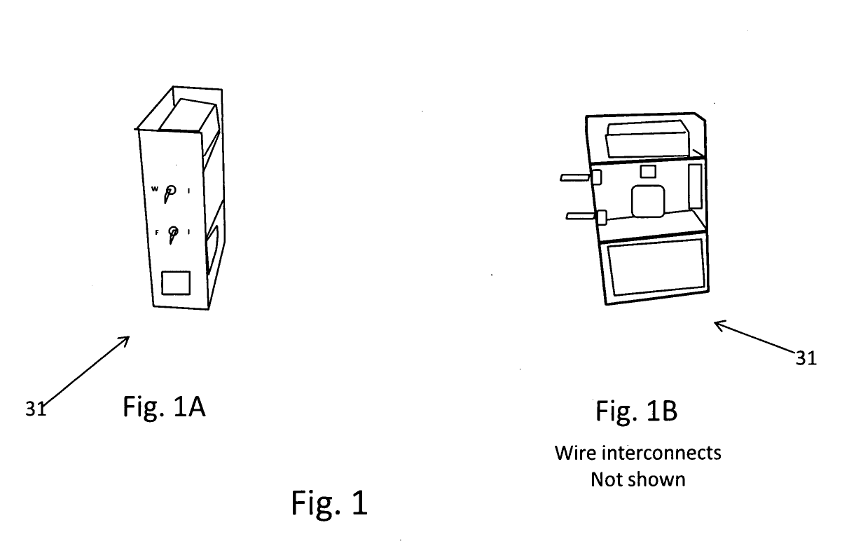

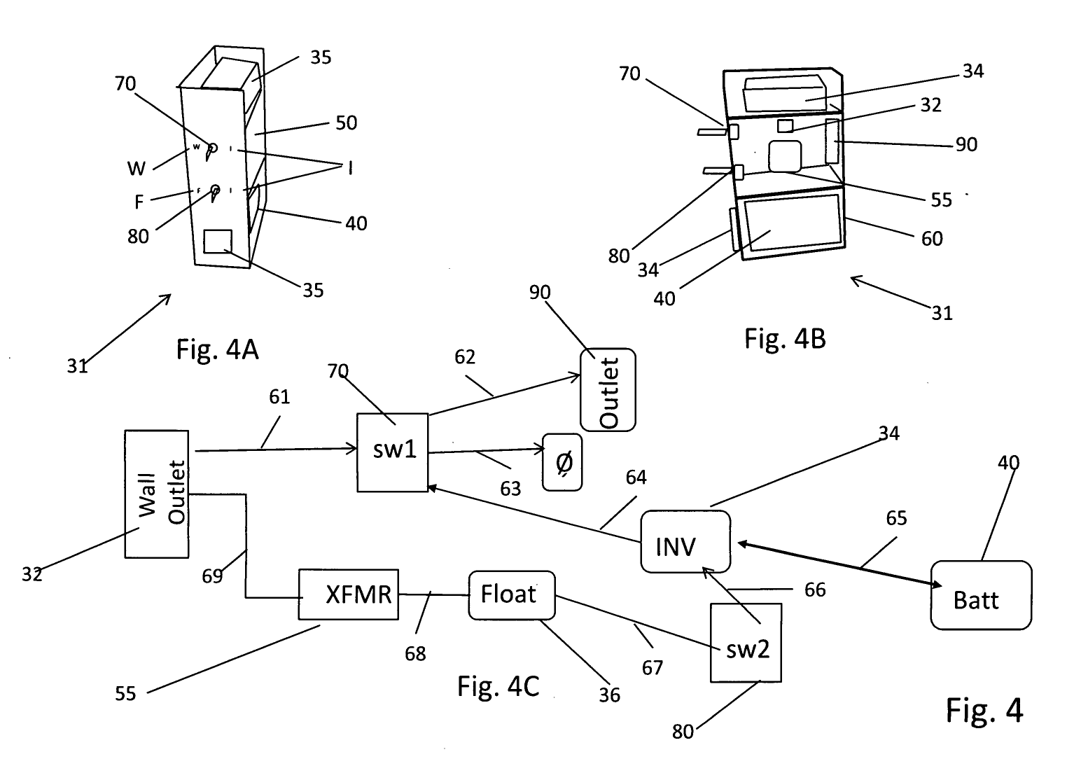

There is shown in FIGS. 1-5 complete details of the concept and an operative embodiment of the Little Power House Emergency Power System 31. In the drawings and illustrations, one notes well that the FIGS. 1-5 detail the special configuration and FIG. 4C shows the potential operative use of this invention. The advantages for the Little Power House Emergency Power System are listed above in the introduction.

The preferred embodiment of the Little Power House Emergency Power System is comprised of:

(a) a three way power switch 32 with a neutral \acute{Ø};

(b) an outlet 90;

(c) an inverter 34;

(d) a battery 40;

(e) a three way charge switch 80;

(f) a float charge device 36;

(g) a transformer 55;

(h) and electrical means to interconnect all the components. The entire Little Power House Emergency Power System 31 of components and means are contained in an encasement 60 with a cover panel 33 in a compact configuration. An alternative embodiment has a means to connect 61 a power source 32 to the power switch 70 of the device 31, where the means is a power cord 25.

The accompanying drawings, which are incorporated in and constitute a part of this specification, illustrate a preferred embodiment of the Little Power House Emergency Power System 31. The drawings together with the summary description given above and a detailed description given below serve to explain the principles of the Little Power House Emergency Power System 31. It is understood, however, that the Little Power House Emergency Power System 31 is not limited to only the precise arrangements and instrumentalities shown.

FIGS. 1A and 1B shows the internal components of the Little Power House 31 from the side (left FIG. 1A) and front (right FIG. 1B).

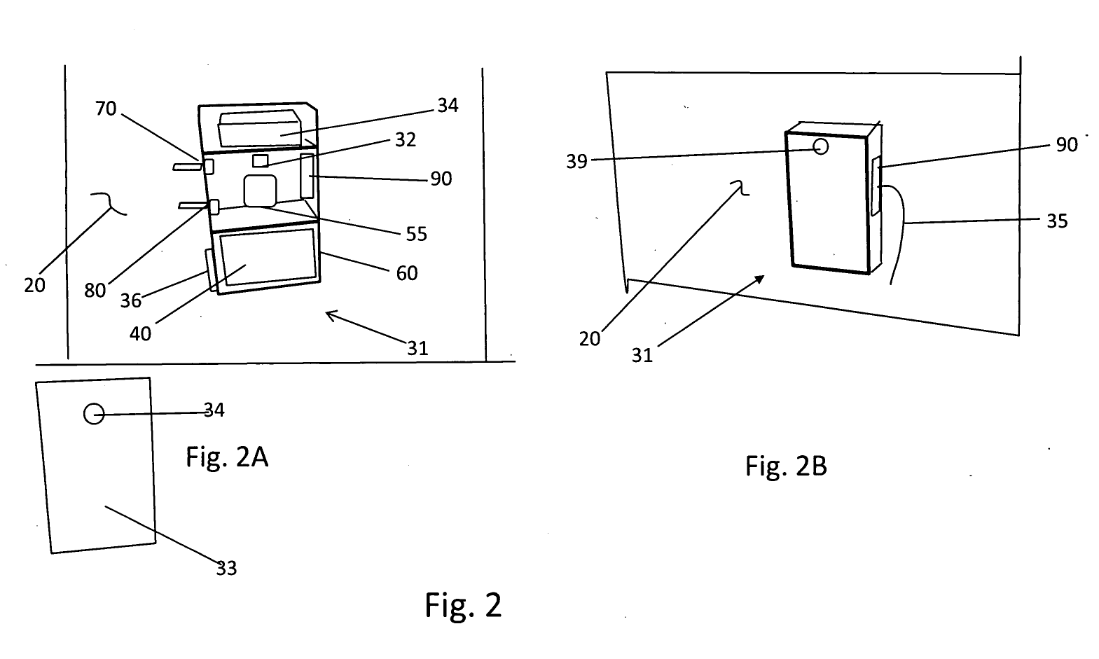

FIGS. 2A and 2B are sketches that depict the unit plugged into an outlet 32 (not shown). The various components are interconnected as discussed below. They are shown on the shelf of the encasement 60 and in the cavity area 50. An example and not a limitation of the device 31 is comprised with the following configuration:
A portable power system that will provide backup lighting in the event of any emergency. The design connects to a 120-Volt wall outlet in any dwelling. Any light/lamp with a 120-Volt plug-in cord plugs into the outlet on the unit. Should a regular building current go out, Little Power House takes over to power the light/lamp with the flip of two switches. The box components include two, 3-way switches, 2 outlet 120-Volt receptacles, a 12 Volt battery, a small inverter, and a float charger. An automatic or manual switch can power the unit. The prototypical unit measures approximately 11″ high, 6¾″ wide, and 3⅛″ deep. The box can measure virtually any size needed according to the size of the components within.

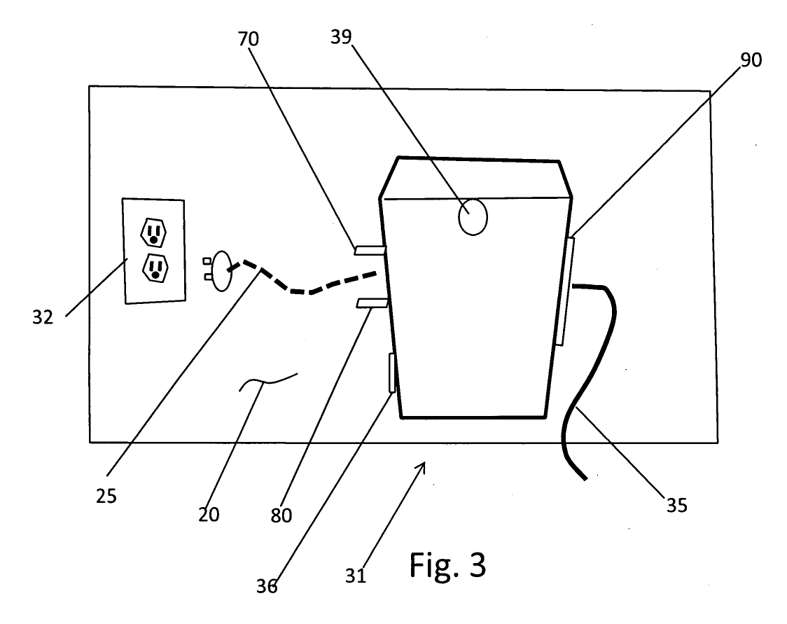

FIGS. 3A and 3B are additional sketches that feature a close view of the product. Here the cover plate handle 39 is shown as well as the optional source cord 25 and user cord 35.

FIGS. 4A, 4B, and 4C illustrate the product (left side FIG. 4A) and in use (front FIG. 4B). FIG. 4C shows the and schematic/flowchart of the system. Here the Little Power House Emergency Power System 31 is comprised of
(a) a three way power switch 32 with a neutral \acute{Ø};
(b) an outlet 90;
(c) an inverter 34;
(d) a battery 40;
(e) a three way charge switch 80;
(f) a float charge device 36;
(g) a transformer 55;
(h) a means to connect 61 a power source 32 to the power switch 70 of the device 31;
(i) a means to connect 62 the power switch 70 to the outlet 90;
(j) a means to connect 63 the power switch 70 to the neutral \acute{Ø};
(k) a means to connect 64 the power switch 70 to the Inverter 34;
(l) a means to connect 65 the inverter 34 to the battery 40;
(m) a means to connect 66 the inverter 34 to the charge switch 80;
(n) a means to connect 67 the charge switch 80 to the float charge device 36;
(o) a means to connect 68 the float charge 34 device to the transformer 55; and
(p) a means to connect 69 the transformer 55 to the power source 32 wherein the entire Little Power House Emergency Power System 31 of components and means are contained in an encasement 60 with a cover panel 33 in a compact configuration.

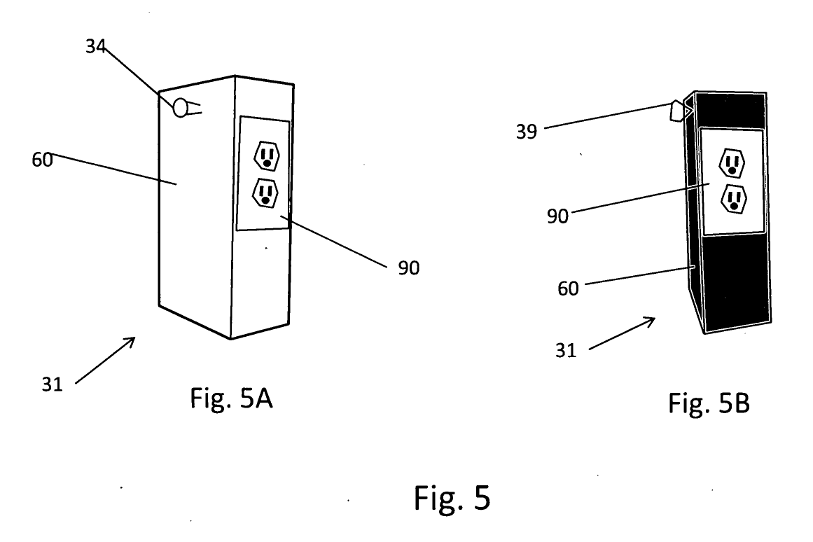

FIGS. 5A and 5B highlight various colors and designs of the Little Power House 31. The front panel 60 and output duplex 90 are illustrated. The other components have been explained above.

All of the details mentioned here are exemplary and not limiting. Other components specific to describing a Little Power House Emergency Power System 31 may be added as a person having ordinary skill in back-up emergency power devices and systems well appreciates.

### Operation of the Preferred Embodiment

The preferred embodiment for the Little Power House Emergency Power System 31 has been described in the above paragraphs. The manner of how the device operates is described below. One skilled in the art of back-up emergency power devices and systems will note that the description above and the operation described here must be taken together to fully illustrate the concept of the Little Power House Emergency Power System 31.

The transformation of electricity from one voltage to another is well understood. Here the device 31 incorporates a compact design and a float charger 36 that keeps the battery 40 at nearly full charge at all times. When the power source 32 is interrupted, the power switch 70 is thrown to inverter and the charge switch 80 is thrown to inverter, Then the battery 40 provides power through the inverter which provide the standby power to the outlet 90.

As an example of use and not as a limitation, the prototypical output is:

With the components are connected in a predetermined manner, based on tests, 23-watt fluorescent lights last over 3½ hours, 18-watt fluorescent lights last almost 4½ hours and 13-watt fluorescent lights last over 6 hours. Exact specifications and design may vary.

With the above description it is to be understood that the Little Power House Emergency Power System 31 is not to be limited to only the disclosed embodiment. The features of the Little Power House Emergency Power System 31 are intended to cover various modifications and equivalent arrangements included within the spirit and scope of the description. The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

What is claimed is:

1. A Little Power House Emergency Power System 31 comprised of
(a) a three way power switch 32 with a neutral \acute{Ø};
(b) an outlet 90;
(c) an inverter 34;
(d) a battery 40;
(e) a three way charge switch 80;
(f) a float charge device 36;
(g) a transformer 55;
(h) a means to connect 61 a power source 32 to the power switch 70 of the device 31;
(i) a means to connect 62 the power switch 70 to the outlet 90;
(j) a means to connect 63 the power switch 70 to the neutral \acute{Ø};
(k) a means to connect 64 the power switch 70 to the Inverter 34;
(l) a means to connect 65 the inverter 34 to the battery 40;
(m) a means to connect 66 the inverter 34 to the charge switch 80;
(n) a means to connect 67 the charge switch 80 to the float charge device 36;
(o) a means to connect 68 the float charge 34 device to the transformer 55; and
(p) a means to connect 69 the transformer 55 to the power source 32
wherein the entire Little Power House Emergency Power System of components and means are contained in an encasement 60 with a cover panel 33 in a compact configuration.

2. The device according to claim 1 wherein the means to connect 61 a power source 32 to the power switch 70 of the device 31 is a power cord 25.
